(19) United States
(12) Patent Application Publication
(10) Pub. No.: US 2016/0053201 A1
(43) Pub. Date: Feb. 25, 2016

(54) Caustic Aqueous Alkylglycoside Stripping Composition

(71) Applicant: Geo-Tech Polymers, LLC, Westerville, OH (US)

(72) Inventors: Douglas R. Gels, Lewis Center, OH (US); Anne B. McCoppin, Powell, OH (US)

(21) Appl. No.: 14/830,614

(22) Filed: Aug. 19, 2015

Related U.S. Application Data
(60) Provisional application No. 62/039,228, filed on Aug. 19, 2014.

(51) Int. Cl. C11D 1/66; B08B 3/10; C11D 3/04

(52) U.S. Cl. CPC C11D 1/662; C11D 3/044; B08B 3/10

(57) ABSTRACT

Compositions, process mixtures, methods, and kits are provided for removing one or more coatings from a polymeric substrate using single-phase aqueous solution. The single-phase aqueous solution may include an inorganic base composition, a surfactant composition including one or more alkylglycosides, and water.

### CROSS-REFERENCE TO RELATED APPLICATIONS

This application claims priority to U.S. Provisional Patent Application No. 62/039,228, filed on Aug. 19, 2014, which is incorporated by reference herein in its entirety.

### BACKGROUND

Polymeric substrates, such as plastic regrind formed in recycling processes, may include undesirable coatings. For example, coatings may include inks, labels, adhesives, metallic films, and the like. It is desirable to process such polymeric substrates to remove undesired coatings prior to further uses of the substrates, such as recycled feedstocks for plastic article manufacture. Existing processes use extremely caustic solutions, high temperatures and/or pressures, or costly reagents to remove coatings.

The present application appreciates that removing coatings from polymeric substrates may be a challenging endeavor.

### SUMMARY

In one embodiment, a single-phase aqueous solution is provided. The single-phase aqueous solution may be used for removing one or more coatings from a polymeric substrate. The single-phase aqueous solution may include an inorganic base composition. The single-phase aqueous solution may include a surfactant composition. The surfactant composition may include one or more alkylglycosides. The single-phase aqueous solution may include water.

In another embodiment, a process mixture is provided. The process mixture may include a polymeric substrate. The polymeric substrate may include one or more coatings. The process mixture may include a single-phase aqueous solution. The single-phase aqueous solution may include an inorganic base composition. The single-phase aqueous solution may include an inorganic base composition. The single-phase aqueous solution may include a surfactant composition. The surfactant composition may include one or more alkylglycosides. The single-phase aqueous solution may include water.

In another embodiment, a method for removing one or more coatings from a polymeric substrate using a single-phase aqueous solution is provided. The method may include providing a single-phase aqueous solution. The single-phase aqueous solution may include an inorganic base composition. The single-phase aqueous solution may include a surfactant composition. The surfactant composition may include one or more alkylglycosides. The single-phase aqueous solution may include water. The method may include providing a polymeric substrate. The polymeric substrate may include one or more coatings. The method may include contacting the single-phase aqueous solution and the polymeric substrate to form a process mixture. The method may include forming the process mixture under conditions effective to remove a portion of the one or more coatings from the polymeric substrate.

In one embodiment, a kit is provided. The kit may be used for making a single-phase aqueous solution for removing one or more coatings from a polymeric substrate. The kit may include one or more of: an inorganic base composition and a surfactant composition. The surfactant composition may include one or more alkylglycosides. The kit may include instructions. The instructions may direct a user to combine the inorganic base composition and the surfactant composition with water to form the single-phase aqueous solution.

### BRIEF DESCRIPTION OF THE DRAWINGS

The accompanying figures, which are incorporated in and constitute a part of the specification, illustrate example methods and apparatuses, and are used merely to illustrate example embodiments.

FIG. 1 is a flow diagram describing an example method.

FIG. 2 is a block diagram of an example kit.

FIG. 3 is a table of results based on EXAMPLES 2 and 3.

### DETAILED DESCRIPTION

The present application relates to compositions, process mixtures, and kits for removing one or more coatings from a polymeric substrate.

In various embodiments, a single-phase aqueous solution is provided. The single-phase aqueous solution may be used for removing one or more coatings from a polymeric substrate. The single-phase aqueous solution may include an inorganic base composition. The single-phase aqueous solution may include a surfactant composition. The surfactant composition may include one or more alkylglycosides.

In some embodiments, the single-phase aqueous solution may include the water in a weight percentage (w/w) of the single-phase aqueous solution of at least about one or more of: 90%, 91%, 92%, 93%, 94%, 95%, 96%, 97%, 98%, 98.1%, 98.2%, 98.3%, 98.4%, 98.5%, 98.6%, 98.7%, 98.8%, and 98.9%. For example, the single-phase aqueous solution may include at least about 94% by weight of water. The single-phase aqueous solution may include the water in a weight percentage range between about any of the preceding weight percentages.

In several embodiments, the inorganic base composition may include one or more of: an alkali metal hydroxide, an alkaline earth metal oxide, or an alkaline earth metal hydroxide. Further, the inorganic base composition may consist of, or may consist essentially of, one or more of: the alkali metal hydroxide, the alkaline earth metal oxide, or the alkaline earth metal hydroxide. As used herein, alkali metals may include, for example, lithium, sodium, potassium, rubidium, or cesium. Alkaline earth metals may include, for example, beryllium, magnesium, calcium, strontium, or barium. For example, the inorganic base composition may include one or more of: lithium hydroxide, sodium hydroxide, potassium hydroxide, magnesium oxide, calcium oxide, magnesium hydroxide, or calcium hydroxide. The inorganic base composition may consist of, or may consist essentially of, one or more of: lithium hydroxide, sodium hydroxide, potassium hydroxide, magnesium oxide, calcium oxide, magnesium hydroxide, or calcium hydroxide. The inorganic base composition may include sodium hydroxide. The inorganic base composition may include potassium hydroxide. The inorganic base composition may consist of, or may consist essentially of, sodium hydroxide. The inorganic base composition may consist of, or may consist essentially of, potassium hydroxide.

In various embodiments, the inorganic base composition may be included in the single-phase aqueous solution in an amount effective to establish a hydroxide concentration in moles/liter (M) in the single-phase aqueous solution of about one or more of: from about 0.0125 M to about 1.25 M; 0.0125 M to 1 M; 0.025 M to about 0.75 M; 0.0625 M to about 0.625 M; 0.0625 M to about 0.563 M; 0.0625 M to 0.5 M; 0.0625 M to about 0.438 M; 0.125 M to about 0.375 M; 0.188 M to about 0.313 M; about 0.025 M; about 0.188 M; about 0.25 M; or any range between any two of the preceding values, e.g., from about 0.0125 M to about 1.25 M, or any one of the preceding values, for example, about 0.025 M, about 0.188 M, or about 0.25 M. The inorganic base composition may be included in the single-phase aqueous solution in a weight percentage (w/w) with respect to the water of one or more of: 0.1%, 0.2%, 0.3%, 0.4%, 0.5%, 0.6%, 0.7%, 0.75, 0.8%, 0.9%, 1%, 1.5%, 2%, 2.5%, 3%, 3.5%, 4%, 4.5%, 5%, 6%, 7%, 8%, 9%, and 10%. For example, the inorganic base composition may include sodium hydroxide in the single-phase aqueous solution in a weight percentage (w/w) with respect to the water of about 1%, about 0.75%, and the like.

In some embodiments, the surfactant composition may include a nonionic surfactant. The surfactant composition may consist essentially of, or may consist of nonionic surfactants. For example, as used herein, the one or more alkylglycosides may be nonionic surfactants. The surfactant composition may include two or more of the alkylglycosides. Each alkyl in the alkylglycosides, e.g., the one or more alkylglycosides, may be independently selected from one of: C₄-C₂₀ alkyl; C₆-C₁₈ alkyl; C₆-C₁₄ alkyl; C₆-C₁₂ alkyl; C₈-C₁₀ alkyl; or C₈ and C₁₀ alkyl. Theone or more alkylglycosides may include one or more alkylglucosides, e.g., two or more alkylglucosides. Each alkyl in the alkylglucosides, e.g., the one or more alkylglucosides, may be independently selected from one of: C₄-C₂₀ alkyl; C₆-C₁₈ alkyl; C₆-C₁₄ alkyl; C₆-C₁₂ alkyl; C₈-C₁₀ alkyl; or C₈ and C₁₀ alkyl. The one or more alkylglycosides may include one or more of capryl glucoside or decyl glucoside. The surfactant composition may include a surfactant blend. For example, the surfactant composition may include a nonionic surfactant blend of C₈-C₁₀ alkylglycoside surfactant and a C₆-C₁₂ polyalkylene glycol alkyl ether surfactant.

In several embodiments, the surfactant composition may also include one or more of: a polyalkylene glycol alkyl ether, a polyethylene glycol alkyl ether, a polypropylene glycol alkyl ether, and a polypropylene glycol polyethylene glycol alkyl ether. A polyalkylene glycol alkyl ether may be referred to herein as an alkoxylated alcohol, e.g., ethoxylated alcohol, propoxylated alcohol, a combination thereof, and the like. The polyalkylene glycol alkyl ether may be represented by R¹—(OR²)ₓ—OH. The group represented by R¹ may be, for example, C₆-C₁₆ alkyl. R¹ may be derived from one or more of: a primary alcohol, a secondary alcohol, a tertiary alcohol, a linear alkyl alcohol, and a branched alkyl alcohol. The group represented by R² may be C₂-C₄ alkyl, e.g., ethylene or substituted ethylene. The variable x may be an integer from 1 to 10. In some embodiments, the group represented by R¹ may be C₈-C₁₂ alkyl; the group represented by R² may be ethyl; and the variable x may be an integer from 3 to 7.

The polypropylene glycol polyethylene glycol alkyl ether may be represented by R³—(OR⁴)_{y}—(OR⁵)_{z}—-OH, R³—(OR⁵)_{z}—(OR⁴)_{y}—OH, R³—(OR⁴)_{y}—(OR⁵)_{z}—(OR⁴)_{y′}—OH, R³—(OR⁵)_{z}—(OR⁴)_{y}—(OR⁵)_{z′}—OH, a combination thereof, or the like. Alternatively, the polypropylene glycol polyethylene glycol alkyl ether may be represented by PPG-z-R³-eth-y. R³ may be, for example, C₆-C₂₀ alkyl. R³ may be derived from one or more of: a primary alcohol, a secondary alcohol, a tertiary alcohol, a linear alkyl alcohol, and a branched alkyl alcohol. The group represented by R⁴ may be C₂, e.g. ethylene. The variable y/y′ may be an integer from 1 to 12. The groups represented by R⁵ may be C₃, e.g. ethylene substituted with a methyl group. The variable z/z′ may be an integer from 1 to 30, e.g., 1 to 12. In some embodiments, the variable z may be an integer from 4 to 8; the variable y may be an integer from 1 to 5; and the group represented by R³ may be C₁₀-C₁₄ alkyl.

In various embodiments, suitable examples of polyalkylene glycol alkyl ethers may include Deceth-x class nonionic surfactants, e.g., represented by R¹—(OR²)ₓ—OH, where the group represented by R¹ is decyl; the group represented by R² is ethyl; and the variable x may be an integer from 1 to 10. For example, one suitable example may be Deceth-5. Other examples of polyalkylene glycol alkyl ethers may include LPS-T91™ (LPS Laboratories, a division of Illinois Tool Works, Inc., Tucker, Ga.); ETHYLAN™ 1005 SA, ETHYLAN™ 1206, ETHYLAN™ TD-60, ETHYLAN™ 324, ETHYLAN™ 954, ETHYLAN™ 1008 SA, ETHYLAN™ 992, ETHYLAN™ 995, ETHYLAN™ NS 500 K, ETHYLAN™ NS 500 LQ, ETHYLAN™ SN-120, ETHYLAN™ SN-90, ETHYLAN™ TD-1407, and the like (AzkoNobel Surface Chemistry LLC, Chicago, Ill.); TERGITOL™ 15-S-9, TERGITOL™ 15-S-3, TERGITOL™ 15-S-5, TERGITOL™ 15-S-7, TERGITOL™ 15-S-12, TERGITOL™ 15-S-15, TERGITOL™ 15-S-20, TERGITOL™ 15-S-30, TERGITOL™ 15-S-40, and the like (Dow Chemical Company, Midland, Mich.); TOMADOL® 1200, TOMADOL® 91-8, TOMADOL® 1-9, TOMADOL® 1-3, TOMADOL® 1-5, TOMADOL® 1-7, TOMADOL® 1-73B, TOMADOL® 23-1, TOMADOL® 23-3, TOMADOL® 23-6.5, TOMADOL® 25-12, TOMADOL® 25-3, TOMADOL® 25-7, TOMADOL® 25-9, TOMADOL® 45-13, TOMADOL® 45-7, TOMADOL® 600, TOMADOL® 900, TOMADOL® 901, TOMADOL® 902, TOMADOL® 910, TOMADOL® 91-2.5, and TOMADOL® 91-6, and the like (Air Products and Chemicals, Inc. Allentown, Pa.).

Suitable examples of polypropylene glycol polyethylene glycol alkyl ethers may include the PPG-z-Laureth-y class nonionic surfactants, e.g., represented by R³—(OR⁴)_{y}—(OR⁵)_{z}—OH or R³—(OR⁵)_{z}—(OR⁴)_{y}—OH, where the group represented by R³ is lauryl, the group R⁴ represents ethylene, the variable y may be an integer from 1 to 12, e.g., 1 to 5; the group R⁵ represents propylene (propylene glycol, PPG), i.e., ethylene substituted with a methyl group, and variable z may be an integer from 1 to 30, e.g., 1 to 12, or 4 to 8. For example, one suitable example may be PPG-6-Laureth-3.

In some embodiments, the surfactant composition may include one or more of: Deceth-5 and PPG-6-Laureth-3. The surfactant composition may include: capryl glucoside, decyl glucoside, Deceth-5, and PPG-6-Laureth-3. The surfactant composition may consist essentially of: capryl glucoside, decyl glucoside, Deceth-5, and PPG-6-Laureth-3. The surfactant composition may consist of: capryl glucoside, decyl glucoside, Deceth-5, and PPG-6-Laureth-3.

In several embodiments, the single-phase aqueous solution may include the surfactant composition in a in a weight percentage (w/w) with respect to the water of one or more of about: 0.005% to 2%; 0.01 to 1.5%; 0.025% to 1%; 0.025% to 0.75%; 0.025% to 0.5%; 0.05% to 0.25%; 0.05% to 0.15%; 0.2%; and 0.1%.

In various embodiments, suitable surfactant compositions including nonionic surfactants such as the one or more alkylglycosides, may include, for example, the alkylglucoside compositions sold under the tradename DEHYPOUND® (e.g., DEHYPOUND® Advanced, and the like, BASF Corporation, Florham Park, N.J.). For example, DEHYPOUND® Advanced may be employed in a weight percentage of from about 0.005% to about 2%, e.g., about 0.1%. Suitable surfactant compositions may include polyalkylene glycol alkyl ether or a polypropylene glycol polyethylene glycol alkyl ether surfactants. For example, DEHYPOUND® Advanced may include Deceth-5 or PPG-6-Laureth-3. Other suitable surfactant compositions including nonionic surfactants including alkylglycosides, may include, for example, compositions sold under the tradename GLUCOPON® (BASF Corporation, Florham Park, N.J.). For example, the surfactant composition may include GLUCOPON® 420UP or GLUCOPON® 425N.

In some embodiments, the single-phase aqueous solution may consist essentially of, or may consist of, the water, the inorganic base composition, and the surfactant composition including the one or more alkylglycosides.

In various embodiments, a process mixture is provided. The process mixture may include a polymeric substrate. The polymeric substrate may include one or more coatings. The process mixture may include a single-phase aqueous solution. The single-phase aqueous solution may include an inorganic base composition. The single-phase aqueous solution may include an inorganic base composition. The single-phase aqueous solution may include a surfactant composition. The surfactant composition may include one or more alkylglycosides. The single-phase aqueous solution may include water.

In some embodiments, the single-phase aqueous solution of the process mixture may include any aspect of the single-phase aqueous solution described herein. For example, the single-phase aqueous solution of the process mixture may include the inorganic base composition, the surfactant composition, and the water as described for the single-phase aqueous solution herein.

In several embodiments, the polymeric substrate may be in pieces or particulates, for example, as part of a plastic regrind, e.g., as part of a recycling process. The polymeric substrate, e.g., plastic regrind, may be in pieces or particles and may be one or more of: recycled; virgin plastic; rigid; flexible; fibrous; a fiber-reinforced resin; mixtures thereof; and the like. The polymeric substrate may include one or more of: polyethylene (PE), polypropylene (PP), polycarbonate (PC), acrylonitrile-butadiene-styrene (AB S),polycarbonate/acrylonitrile-butadiene-styrene (PC/ABS), polycarbonate/acrylonitrile-styrene-acrylate (PC/ASA); and the like. The one or more coatings may include one or more of: a paint, an ink, a dye, a powder coat, a paper label, a plastic label, an adhesive, a barrier coating, a metalized coating or a bio-coating. The bio-coating may be, for example, protein-based, oligo-saccharide based, and the like. The metalized coating may include a continuous film or metal particulates. The described solutions, process mixtures, methods, and kits may be particularly effective against metalized films.

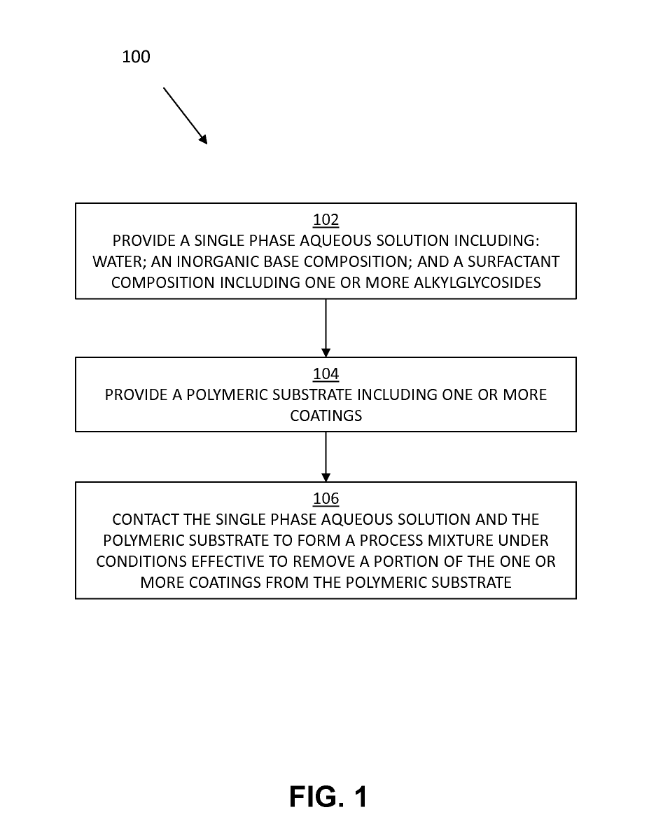

In various embodiments, a method for removing one or more coatings from a polymeric substrate using a single-phase aqueous solution is provided. FIG. 1 is a flow diagram of example method 100 for removing one or more coatings from a polymeric substrate using a single-phase aqueous solution. Method 100 may include 102 providing a single-phase aqueous solution. The single-phase aqueous solution may include an inorganic base composition. The single-phase aqueous solution may include a surfactant composition. The surfactant composition may include one or more alkylglycosides. The single-phase aqueous solution may include water. Method 100 may include 104 providing a polymeric substrate. The polymeric substrate may include one or more coatings. Method 100 may include 106 contacting the single-phase aqueous solution and the polymeric substrate to form a process mixture. The method may include forming the process mixture under conditions effective to remove a portion of the one or more coatings from the polymeric substrate.

In some embodiments, the conditions effective to remove a portion of the one or more coatings from the polymeric substrate may include heating the process mixture, e.g., to maintain or reach a desired temperature. For example, the process mixture may be heated at a temperature of about one or more of: 60° C. to 100° C.; 65° C. to 100° C.; 70° C. to 100° C.; 75° C. to 95° C.; 80° C. to 90° C.; or 85° C. The process mixture may be heated for a period of time, for example, including one or more of: between about 5 minutes and about 24 hours; between about 10 minutes and about 12 hours; between about 15 minutes and about 8 hours; between about 20 minutes and about 4 hours; between about 20 minutes and about 3 hours; between about 20 minutes and about 2 hours; or between about 20 minutes and about 1 hour.

In several embodiments, the conditions effective to remove a portion of the one or more coatings from the polymeric substrate may include determining an initial coating amount. The conditions effective to remove a portion of the one or more coatings from the polymeric substrate may include agitating the process mixture. Agitation may be accomplished by conventional methods, such as stirring, tumbling, vibration or sonication, agitation by boiling, and the like. The conditions effective to remove a portion of the one or more coatings from the polymeric substrate may include heating and agitating the process mixture. The conditions effective to remove a portion of the one or more coatings from the polymeric substrate may include determining a process coating amount that is less than about a percentage of the initial coating amount. The percentage of the initial coating amount may one or more of about: 20%, 15%, 14%, 13%, 12%, 11%, 10%, 9%, 8%, 7%, 6%, 5%, 4%, 3%, 2%, or 1%, e.g., 10%, or a range between any of the preceding values, for example, between about 20% and about 1%. The conditions effective to remove a portion of the one or more coatings from the polymeric substrate may include recovering the polymeric substrate upon determining the process coating amount is less than about the percentage of the initial coating amount. Each of the conditions effective to remove a portion of the one or more coatings from the polymeric substrate may be implemented as individual method steps. For example, the method may include agitating the process mixture.

In various embodiments, the method may include recovering the polymeric substrate after removal of the portion of the one or more coatings. The method may include recovering at least a portion of the single-phase aqueous solution after removal of the portion of the one or more coatings. The method, e.g., the conditions effective to remove a portion of the one or more coatings from the polymeric substrate, may include batch operation. The method, e.g., the conditions effective to remove a portion of the one or more coatings from the polymeric substrate, may include continuous operation.

In some embodiments, the single-phase aqueous solution of the method may include any aspect of the single-phase aqueous solution described herein. For example, the single-phase aqueous solution of the method may include the inorganic base composition, the surfactant composition, and the water as described for the single-phase aqueous solution herein. Likewise, the process mixture of the method may include any aspect of the process mixture described herein. For example, the process mixture of the method may include the single-phase aqueous solution as described herein, e.g., for the process mixture. Also, the polymeric substrate of the method may include any aspect of the polymeric substrate described herein. For example, the polymeric substrate of the method may include the polymeric substrate including one or more coatings as described herein, e.g., for the process mixture.

In several embodiments, the method may include a step of forming the single-phase aqueous solution including any aspect of the single-phase aqueous solution described herein. For example, providing the single-phase aqueous solution may include forming the single-phase aqueous solution including sodium hydroxide in a molarity of from about 0.0125 M to about 1.25 M; 0.0125 M to 1 M; 0.025 M to about 0.75 M; 0.0625 M to about 0.625 M; 0.0625 M to about 0.563 M; 0.0625 M to 0.5 M; 0.0625 M to about 0.438 M; 0.125 M to about 0.375 M; 0.188 M to about 0.313 M; about 0.025 M; about 0.188 M; about 0.25 M; or any range between any two of the preceding values, e.g., from about 0.0125 M to about 1.25 M, or any one of the preceding values, for example, about 0.025 M, about 0.188 M, or about 0.25 M. Providing the single-phase aqueous solution may include forming the single-phase aqueous solution including sodium hydroxide in a weight percentage (w/w) with respect to the water of one or more of: 0.1%, 0.2%, 0.3%, 0.4%, 0.5%, 0.6%, 0.7%, 0.75, 0.8%, 0.9%, 1%, 1.5%, 2%, 2.5%, 3%, 3.5%, 4%, 4.5%, 5%, 6%, 7%, 8%, 9%, and 10%. For example, the inorganic base composition may include sodium hydroxide in the single-phase aqueous solution in a weight percentage (w/w) with respect to the water of about 1%, about 0.75%, and the like. Also, for example, the method may include forming the single-phase aqueous solution consisting essentially of, or consisting of, the water, the inorganic base composition, and the surfactant composition including the one or more alkylglycosides.

Further, for example, in some embodiments, the method may include forming the single-phase aqueous solution including the surfactant composition in a in a weight percentage (w/w) with respect to the water of one or more of about: 0.005% to 2%; 0.01 to 1.5%; 0.025% to 1%; 0.025% to 0.75%; 0.025% to 0.5%; 0.05% to 0.25%; 0.05% to 0.15%; 0.2%; and 0.1%.

In some embodiments, the method may include forming the single-phase aqueous solution including the water in a weight percentage (w/w) of the single-phase aqueous solution of at least about one or more of: 94%, 95%, 96%, 97%, 98%, 98.1%, 98.2%, 98.3%, 98.4%, 98.5%, 98.6%, 98.7%, 98.8%, or 98.9%, or a range between any of the preceding values, for example, between about 94% and about 98.9%.

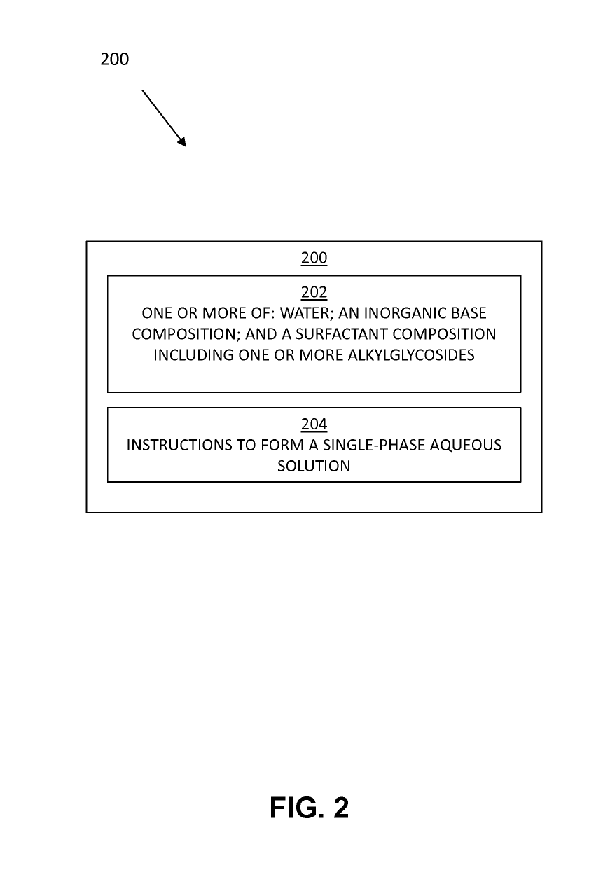

In various embodiments, a kit is provided. FIG. 2 is a block diagram of example kit 200 providing a single-phase aqueous solution for removing one or more coatings from a polymeric substrate. The kit may include 202 one or more of: an inorganic base composition and a surfactant composition. The surfactant composition may include one or more alkylglycosides. The kit may include instructions 204. Instructions 204 may direct a user to combine the inorganic base composition and the surfactant composition with water to form the single-phase aqueous solution.

In some embodiments, the kit may include the inorganic base composition and the surfactant composition. The kit may include the inorganic base composition as a dry composition. The kit may include the inorganic base composition and the surfactant composition together as one of: a neat mixture; an aqueous concentrate; or the single-phase aqueous solution, e.g., in ready-to-use form.

In several embodiments, the instructions may further direct the user to form a process mixture by contacting the single-phase aqueous solution to the polymeric substrate including the one or more coatings. The instructions may direct the user to use the polymeric substrate including one or more of: polyethylene (PE), polypropylene (PP), polycarbonate (PC), acrylonitrile-butadiene-styrene (ABS),polycarbonate/acrylonitrile-butadiene-styrene (PC/ABS), polycarbonate/acrylonitrile-styrene-acrylate (PC/ASA); and the like. The instructions may direct the user to use the polymeric substrate, the one or more coatings including one or more of: a paint, an ink, a dye, a powder coat, a paper label, a plastic label, an adhesive, a barrier coating, a metalized coating or a bio-coating.

In various embodiments, the instructions may direct the user to remove the one or more coatings from the polymeric substrate including one or more of: heating the process mixture, agitating the process mixture, recovering the polymeric substrate after removal of a portion of the one or more coatings, or recovering at least a portion of the single-phase aqueous solution. The instructions may direct the user to remove the one or more coatings from the polymeric substrate including heating the process mixture at a temperature of about one or more of: 60° C. to 100° C.; 65° C. to 100° C.; 70° C. to 100° C.; 75° C. to 95° C.; 80° C. to 90° C.; 82° C.; and 85° C. The instructions may direct the user to remove the one or more coatings from the polymeric substrate including one of: batch operation or continuous operation.

In some embodiments, the instructions may direct the user to remove the one or more coatings from the polymeric substrate by one or more of: determining an initial coating amount; heating and agitating the process mixture; determining a process coating amount that is less than about a percentage of the initial coating amount; and recovering the polymeric substrate upon determining the process coating amount is less than about the percentage of the initial coating amount. The percentage of the initial coating amount may be one or more of about: 20%, 15%, 14%, 13%, 12%, 11%, 10%, 9%, 8%, 7%, 6%, 5%, 4%, 3%, 2%, and 1%.

In several embodiments, the instructions may direct the user to form the single-phase aqueous solution including the inorganic base composition in an amount effective to establish a hydroxide concentration in moles/liter (M) of about one or more of: 0.0125 M to 1.25 M; 0.0125 M to 1 M; 0.025 M to 0.75 M; 0.0625 M to 0.625 M; 0.0625 M to 0.563 M; 0.0625 M to 0.5 M; 0.0625 M to 0.438 M; 0.125 M to 0.375 M; 0.188 M to 0.313 M; 0.05 M; 0.025 M; 0.188 M; and 0.25 M. For example, the instructions may direct the user to form the single-phase aqueous solution including the inorganic base composition including sodium hydroxide in a weight percentage (w/w) with respect to the water of about 1%. For example, the instructions may direct the user to form the single-phase aqueous solution including the surfactant composition in a in a weight percentage (w/w) with respect to the water of one or more of about: 0.005% to 2%; 0.01 to 1.5%; 0.025% to 1%; 0.025% to 0.75%; 0.025% to 0.5%; 0.05% to 0.25%; 0.05% to 0.15%; 0.2%; and 0.1%. For example, the instructions may direct the user to form the single-phase aqueous solution including the water in a weight percentage (w/w) of the single-phase aqueous solution of at least about one or more of: 95%, 96%, 97%, 98%, 98.1%, 98.2%, 98.3%, 98.4%, 98.5%, 98.6%, 98.7%, 98.8%, and 98.9%. For example, the instructions may direct the user to form the single-phase aqueous solution consisting essentially of, or consisting of, the water, the inorganic base composition, and the surfactant composition including the one or more alkylglycosides.

In some embodiments, the single-phase aqueous solution of the kit may include any aspect of the single-phase aqueous solution described herein. For example, the single-phase aqueous solution of the kit may include the inorganic base composition, the surfactant composition, and the water as described for the single-phase aqueous solution herein. Likewise, the process mixture of the kit may include any aspect of the process mixture described herein. For example, the process mixture of the method may include the single-phase aqueous solution as described herein, e.g., for the process mixture. Also, the polymeric substrate of the method may include any aspect of the polymeric substrate described herein. For example, the polymeric substrate of the method may include the polymeric substrate including one or more coatings as described herein, e.g., for the process mixture. Further, the instructions of the kit may include instructions to conduct any of the method steps described herein.

Various embodiments herein may recite the term “including,” or, in the claims, the term “comprising,” and their grammatical variants. For each such embodiment, corresponding additional embodiments are explicitly contemplated where the term “comprising” is replaced with “consisting essentially of” and “consisting of”

### EXAMPLES

### Example 1

Approximately 11,793 kg. of hot water, about 85° C., was added to a mixing tank. To the water, approximately 4,990 kg of a polypropylene flake substrate was added gravimetrically while mixing to form a slurry. The polypropylene flake substrate was a rigid plastic regrind, about 0.953 cm in size, and included a mixture of ink and metalized coatings. The initial coating contaminant was determined to be about 35%. Once the mixing ratio was determined to be correct, reagents were added to the slurry stepwise in the following order. The reagents were added in amounts to make a single-phase aqueous solution, in the following weight percentages, determined by dividing the weight of each reagent by the weight of the water. Thus, 236 kg of sodium hydroxide as a 50% aqueous solution were added to result in a 1% w/w concentration of sodium hydroxide. Further, 11.8 kg of DEHYPOUND® Advanced (BASF Corporation, Florham Park, N.J.), a nonionic surfactant composition, including alkylglycosides, was added to result in a 0.1% w/w concentration of surfactant composition.

Samples were taken every thirty minutes starting at the two hour mark until the screen-printed polypropylene flake substrate was substantially free from the screen-printed ink coating. At approximately 2.5 hours, the polypropylene flake substrate was determined to be 96% clean. At approximately 3.5 hours, the polypropylene flake substrate was determined to be >98% clean. The slurry was dewatered, rinsed and dried using conventional techniques to separate the washed flake from the unwanted products and collected for subsequent use, e.g., recycling. The single-phase aqueous solution may be recovered using filtering techniques for re-use or recovery of the reagents.

### Example 2

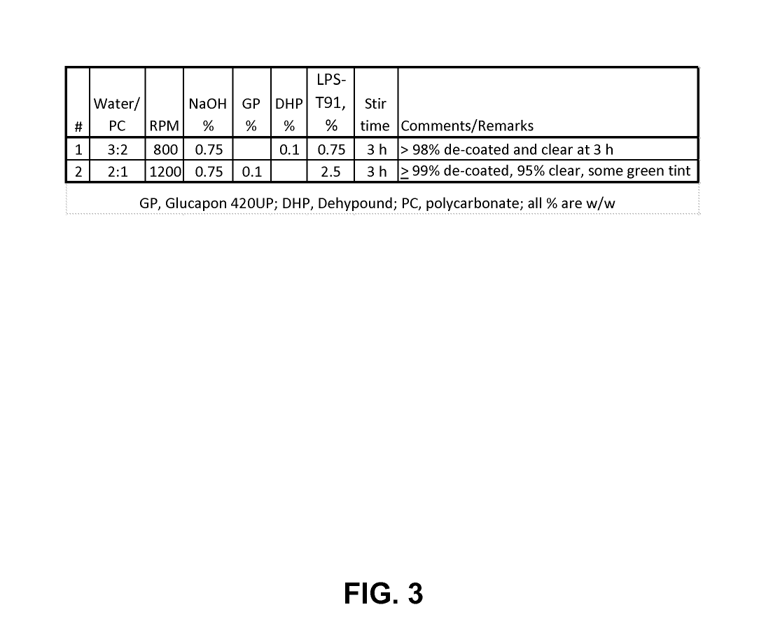

Approximately 2.72 kg of water were added to a mixing tank and heated to about 82° C. While the water was being brought to 82 ° C., and stirred at approximately 800 RPM, 0.75% (w/w) of 50% (w/v) solution of NaOH, 0.10% (w/w) of DEHYPOUND® Advanced (BASF Corporation, Florham Park, N.J.), 0.75% LPS-T91™ (LPS Laboratories, a division of Illinois Tool Works, Inc., Tucker, Ga.), and 1.8 kg of a polycarbonate CD/DVD material were added to the mixing tank. The mixture was heated and stirred for approximately 3 h. The recovered polycarbonate material obtained was >98% de-coated and clear in appearance. Details of EXAMPLE 2 are shown in the table in FIG. 3, entry 1.

### Example 3

Approximately 3.63 kg of water were added to a mixing tank and heated to about 82° C. While the water was being brought to 82° C., and stirred at approximately 1200 RPM, 0.75% (w/w) of 50% (w/v) solution of NaOH, 0.10% (w/w) of GLUCOPON® 420UP (BASF Corporation, Florham Park, N.J.), 2.50% LPS-T91™ (LPS Laboratories, a division of Illinois Tool Works, Inc., Tucker, Ga.), and 1.8 kg of a polycarbonate CD/DVD material were added to the mixing tank. The mixture was heated and stirred for approximately 3 h. The recovered polycarbonate material obtained was >99% de-coated and about 95% clear in appearance. Details of EXAMPLE 3 are shown in the table in FIG. 3, entry 2.

To the extent that the term “includes” or “including” is used in the specification or the claims, it is intended to be inclusive in a manner similar to the term “comprising” as that term is interpreted when employed as a transitional word in a claim. Furthermore, to the extent that the term “or” is employed (e.g., A or B) it is intended to mean “A or B or both.” When the applicants intend to indicate “only A or B but not both” then the term “only A or B but not both” will be employed. Thus, use of the term “or” herein is the inclusive, and not the exclusive use. See Bryan A. Garner, A Dictionary of Modern Legal Usage 624 (2d. Ed. 1995). Also, to the extent that the terms “in” or “into” are used in the specification or the claims, it is intended to additionally mean “on” or “onto.” To the extent that the term “selectively” is used in the specification or the claims, it is intended to refer to a condition of a component wherein a user of the apparatus may activate or deactivate the feature or function of the component as is necessary or desired in use of the apparatus. To the extent that the terms “operatively coupled” or “operatively connected” are used in the specification or the claims, it is intended to mean that the identified components are connected in a way to perform a designated function. To the extent that the term “substantially” is used in the specification or the claims, it is intended to mean that the identified components have the relation or qualities indicated with degree of error as would be acceptable in the subject industry.

As used in the specification and the claims, the singular forms “a,” “an,” and “the” include the plural unless the singular is expressly specified. For example, reference to “a compound” may include a mixture of two or more compounds, as well as a single compound.

As used herein, the term “about” in conjunction with a number is intended to include ±10% of the number. In other words, “about 10” may mean from 9 to 11.

As used herein, the terms “optional” and “optionally” mean that the subsequently described circumstance may or may not occur, so that the description includes instances where the circumstance occurs and instances where it does not.

As stated above, while the present application has been illustrated by the description of embodiments thereof, and while the embodiments have been described in considerable detail, it is not the intention of the applicants to restrict or in any way limit the scope of the appended claims to such detail. Additional advantages and modifications will readily appear to those skilled in the art, having the benefit of the present application. Therefore, the application, in its broader aspects, is not limited to the specific details, illustrative examples shown, or any apparatus referred to. Departures may be made from such details, examples, and apparatuses without departing from the spirit or scope of the general inventive concept.

As used herein, “substituted” refers to an organic group as defined below (e.g., an alkyl group) in which one or more bonds to a hydrogen atom contained therein may be replaced by a bond to non-hydrogen or non-carbon atoms. Substituted groups also include groups in which one or more bonds to a carbon(s) or hydrogen(s) atom may be replaced by one or more bonds, including double or triple bonds, to a heteroatom. A substituted group may be substituted with one or more substituents, unless otherwise specified. In some embodiments, a substituted group may be substituted with 1, 2, 3, 4, 5, or 6 substituents. Examples of substituent groups include: halogens (i.e., F, Cl, Br, and I); hydroxyls; alkoxy, alkenoxy, aryloxy, aralkyloxy, heterocyclyloxy, and heterocyclylalkoxy groups; carbonyls (oxo); carboxyls; esters; urethanes; oximes; hydroxylamines; alkoxyamines; aralkoxyamines; thiols; sulfides; sulfoxides; sulfones; sulfonyls; sulfonamides; amines; N-oxides; hydrazines; hydrazides; hydrazones; azides; amides; ureas; amidines; guanidines; enamines; imides; isocyanates; isothiocyanates; cyanates; thiocyanates; imines; nitro groups; or nitriles (i.e., CN). A “per”-substituted compound or group is a compound or group having all or substantially all substitutable positions substituted with the indicated substituent. For example, 1,6-diiodo perfluoro hexane indicates a compound of formula C₆F₁₂I₂, where all the substitutable hydrogens have been replaced with fluorine atoms.

Substituted ring groups such as substituted cycloalkyl, aryl, heterocyclyl and heteroaryl groups also include rings and ring systems in which a bond to a hydrogen atom may be replaced with a bond to a carbon atom. Substituted cycloalkyl, aryl, heterocyclyl and heteroaryl groups may also be substituted with substituted or unsubstituted alkyl, alkenyl, and alkynyl groups as defined below.

Alkyl groups include straight chain and branched chain alkyl groups having from 1 to 12 carbon atoms, and typically from 1 to 10 carbons or, in some examples, from 1 to 8, 1 to 6, or 1 to 4 carbon atoms. Examples of straight chain alkyl groups include groups such as methyl, ethyl, n-propyl, n-butyl, n-pentyl, n-hexyl, n-heptyl, and n-octyl groups. Examples of branched alkyl groups include, but are not limited to, isopropyl, iso-butyl, sec-butyl, tent-butyl, neopentyl, isopentyl, and 2,2-dimethylpropyl groups. Representative substituted alkyl groups may be substituted one or more times with substituents such as those listed above and include, without limitation, haloalkyl (e.g., trifluoromethyl), hydroxyalkyl, thioalkyl, aminoalkyl, alkylaminoalkyl, dialkylaminoalkyl, alkoxyalkyl, or carboxyalkyl.

Cycloalkyl groups include mono-, bi- or tricyclic alkyl groups having from 3 to 12 carbon atoms in the ring(s), or, in some embodiments, 3 to 10, 3 to 8, or 3 to 4, 5, or 6 carbon atoms. Exemplary monocyclic cycloalkyl groups include, but are not limited to, cyclopropyl, cyclobutyl, cyclopentyl, cyclohexyl, cycloheptyl, and cyclooctyl groups. In some embodiments, the cycloalkyl group has 3 to 8 ring members, whereas in other embodiments, the number of ring carbon atoms ranges from 3 to 5, 3 to 6, or 3 to 7. Bi- and tricyclic ring systems include both bridged cycloalkyl groups and fused rings, such as, but not limited to, bicyclo[2.1.1]hexane, adamantyl, or decalinyl. Substituted cycloalkyl groups may be substituted one or more times with non-hydrogen and non-carbon groups as defined above. However, substituted cycloalkyl groups also include rings that may be substituted with straight or branched chain alkyl groups as defined above. Representative substituted cycloalkyl groups may be mono-substituted or substituted more than once, such as, but not limited to, 2,2-, 2,3-, 2,4- 2,5- or 2,6-disubstituted cyclohexyl groups, which may be substituted with substituents such as those listed above.

Aryl groups may be cyclic aromatic hydrocarbons that do not contain heteroatoms. Aryl groups herein include monocyclic, bicyclic and tricyclic ring systems. Aryl groups include, but are not limited to, phenyl, azulenyl, heptalenyl, biphenyl, fluorenyl, phenanthrenyl, anthracenyl, indenyl, indanyl, pentalenyl, and naphthyl groups. In some embodiments, aryl groups contain 6-14 carbons, and in others from 6 to 12 or even 6-10 carbon atoms in the ring portions of the groups. In some embodiments, the aryl groups may be phenyl or naphthyl. Although the phrase “aryl groups” may include groups containing fused rings, such as fused aromatic-aliphatic ring systems (e.g., indanyl or tetrahydronaphthyl), “aryl groups” does not include aryl groups that have other groups, such as alkyl or halo groups, bonded to one of the ring members. Rather, groups such as tolyl may be referred to as substituted aryl groups. Representative substituted aryl groups may be mono-substituted or substituted more than once. For example, monosubstituted aryl groups include, but are not limited to, 2-, 3-, 4-, 5-, or 6-substituted phenyl or naphthyl, which may be substituted with substituents such as those above.

Aralkyl groups may be alkyl groups as defined above in which a hydrogen or carbon bond of an alkyl group may be replaced with a bond to an aryl group as defined above. In some embodiments, aralkyl groups contain 7 to 16 carbon atoms, 7 to 14 carbon atoms, or 7 to 10 carbon atoms. Substituted aralkyl groups may be substituted at the alkyl, the aryl or both the alkyl and aryl portions of the group. Representative aralkyl groups include but are not limited to benzyl and phenethyl groups and fused (cycloalkylaryl)alkyl groups such as 4-indanylethyl. Substituted aralkyls may be substituted one or more times with substituents as listed above.

Groups described herein having two or more points of attachment (i.e., divalent, trivalent, or polyvalent) within the compound of the technology may be designated by use of the suffix, “ene.” For example, divalent alkyl groups may be alkylene groups, divalent aryl groups may be arylene groups, divalent heteroaryl groups may be heteroarylene groups, and so forth. In particular, certain polymers may be described by use of the suffix “ene” in conjunction with a term describing the polymer repeat unit.

Alkoxy groups may be hydroxyl groups (—OH) in which the bond to the hydrogen atom may be replaced by a bond to a carbon atom of a substituted or unsubstituted alkyl group as defined above. Examples of linear alkoxy groups include, but are not limited to, methoxy, ethoxy, propoxy, butoxy, pentoxy, or hexoxy. Examples of branched alkoxy groups include, but are not limited to, isopropoxy, sec-butoxy, tent-butoxy, isopentoxy, or isohexoxy. Examples of cycloalkoxy groups include, but are not limited to, cyclopropyloxy, cyclobutyloxy, cyclopentyloxy, or cyclohexyloxy. Representative substituted alkoxy groups may be substituted one or more times with substituents such as those listed above.

The various aspects and embodiments disclosed herein are for purposes of illustration and are not intended to be limiting, with the true scope and spirit being indicated by the following claims.

1. A single-phase aqueous solution for removing one or more coatings from a polymeric substrate, comprising:
an inorganic base composition;
a surfactant composition comprising one or more alkylglycosides; and
water.

2. The single-phase aqueous solution of claim 1, comprising the inorganic base composition in an amount effective to establish a hydroxide concentration in moles/liter (M) of about 0.0125 M to 1.25 M.

3. The single-phase aqueous solution of claim 1, the inorganic base composition comprising sodium hydroxide in a weight percentage (w/w) with respect to the water of less than about 1%.

4. The single-phase aqueous solution of claim 1, each alkyl in the one or more alkylglycosides being independently selected from C₆-C₁₈ alkyl.

5. The single-phase aqueous solution of claim 1, the surfactant composition further comprising one or more of: a polyalkylene glycol alkyl ether and a polypropylene glycol polyethylene glycol alkyl ether.

6. The single-phase aqueous solution of claim 1, the surfactant composition comprising one or more of: capryl glucoside, decyl glucoside, Deceth-5, and PPG-6-Laureth-3.

7. The single-phase aqueous solution of claim 1, comprising the surfactant composition in a in a weight percentage (w/w) with respect to the water of about 0.005% to 2%.

8. A method 100 for removing one or more coatings from a polymeric substrate using a single-phase aqueous solution, comprising:
102 providing a single-phase aqueous solution comprising: an inorganic base composition; a surfactant composition, the surfactant composition comprising one or more alkylglycosides; and water;
104 providing a polymeric substrate, the polymeric substrate comprising one or more coatings; and
106 contacting the single-phase aqueous solution and the polymeric substrate to form a process mixture under conditions effective to remove a portion of the one or more coatings from the polymeric substrate.

9. The method of claim 8, the conditions effective to remove a portion of the one or more coatings from the polymeric substrate comprising heating the process mixture at a temperature of about 60° C. to 100° C.

10. The method of claim 8, the conditions effective to remove a portion of the one or more coatings from the polymeric substrate comprising: determining an initial coating amount; heating and agitating the process mixture; determining a process coating amount that is less than about a percentage of the initial coating amount; and recovering the polymeric substrate upon determining the process coating amount is less than about the percentage of the initial coating amount, the percentage of the initial coating amount being one or more of about: 20%, 15%, 14%, 13%, 12%, 11%, 10%, 9%, 8%, 7%, 6%, 5%, 4%, 3%, 2%, or 1%.

11. The method of claim 8, the polymeric substrate comprising one or more of: polyethylene (PE), polypropylene (PP), polycarbonate (PC), acrylonitrile-butadiene-styrene (ABS),polycarbonate/acrylonitrile-butadiene-styrene (PC/ABS), and polycarbonate/acrylonitrile-styrene-acrylate (PC/ASA).

12. The method of claim 8, the providing the single-phase aqueous solution comprising forming the single-phase aqueous solution comprising the inorganic base composition in an amount effective to establish a hydroxide concentration in moles/liter (M) of about 0.0125 M to 1.25 M.

13. The method of claim 8, the one or more alkylglycosides comprising one or more alkylglucosides, each alkyl in the one or more alkylglucosides being independently selected from C₆-C₁₂ alkyl.

14. The method of claim 8, the one or more of the alkylglycosides comprising one or more of: capryl glucoside or decyl glucoside.

15. The method of claim 8, the surfactant composition comprising one or more of: capryl glucoside, decyl glucoside, Deceth-5, and PPG-6-Laureth-3.

16. The method of claim 8, the providing the single-phase aqueous solution comprising forming the single-phase aqueous solution comprising the surfactant composition in a in a weight percentage (w/w) with respect to the water of about: 0.005% to 2%.

17. A kit 200 for making a single-phase aqueous solution for removing one or more coatings from a polymeric substrate, comprising:
202 one or more of: an inorganic base composition and a surfactant composition, the surfactant composition comprising one or more alkylglycosides; and
204 instructions, the instructions directing a user to combine the inorganic base composition and the surfactant composition with water to form the single-phase aqueous solution.

18. The kit of claim 17, comprising the inorganic base composition and the surfactant composition.

19. The kit of claim 17, the instructions further directing the user to form a process mixture by contacting the single-phase aqueous solution to the polymeric substrate comprising the one or more coatings, the polymeric substrate comprising one or more of: polyethylene (PE), polypropylene (PP), polycarbonate (PC), acrylonitrile-butadiene-styrene (ABS),polycarbonate/acrylonitrile-butadiene-styrene (PC/ABS), and polycarbonate/acrylonitrile-styrene-acrylate (PC/ASA).

20. The kit of claim 17, the surfactant composition comprising one or more of: a polyalkylene glycol alkyl ether or a polypropylene glycol polyethylene glycol alkyl ether.

21. The kit of claim 17, the surfactant composition comprising one or more of: capryl glucoside, decyl glucoside, Deceth-5, and PPG-6-Laureth-3.
